(19) United States
(12) Patent Application Publication
(10) Pub. No.: US 2007/0103499 A1
(43) Pub. Date: May 10, 2007

(54) Color registration apparatus and method

(75) Inventor: Myong-hun Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/584,570

(22) Filed: Oct. 23, 2006

(30) Foreign Application Priority Data
Nov. 4, 2005 (KR) 2005-0105470

(51) Int. Cl. B41J 29/393

(52) U.S. Cl. 347/19

(57) ABSTRACT

A color registration apparatus and method capable of performing color registration without errors regardless of concentration of a developing agent is provided. The color registration apparatus determines a light emitting intensity irradiating onto a registration mark and a minimum light receiving intensity with which the registration mark is identified according to the concentration of the developing agent. The color registration apparatus includes a mark forming unit forming a concentration mark for each color and forming a registration mark for each color in response to a color registration control signal, a mark sensing unit sensing the concentration mark by emitting a plurality of first emitted lights comprising different intensities and sensing the registration mark by emitting second emitted lights, an examining unit comparing the intensities of first sensed lights with a predetermined reference value and generating the color registration control signal in response to the comparison results, a calculating unit that calculates the intensity of the second emitted light using the intensities of the plurality of first emitted lights and the intensities of the plurality of first sensed lights in condition that the intensities of second sensed light are greater than a predetermined value and a color registration unit performing color registration using the intensity of the second sensed light than a predetermined threshold value, wherein the first sensed light is a light reflected from the concentration mark, and the second sensed light reflected from the registration mark.

### CROSS-REFERENCE TO RELATED PATENT APPLICATION

This application claims the benefit under 35 U.S.C. §119(a) of Korean Patent Application No. 10-2005-0105470, filed on Nov. 04, 2005, in the Korean Intellectual Property Office, the entire disclosure of which is hereby incorporated by reference.

### BACKGROUND OF THE INVENTION

1. Field of the Invention

The present invention relates to a color registration operation performed in an electro-photographic printer such as a laser printer. More particularly, the present invention relates to a color registration apparatus which performs color registration without errors regardless of a concentration of a developing agent by determining the intensity of light irradiated onto a registration mark and the minimum intensity of sensed light necessary to identify the registration mark according to the concentration of the developing agent and a method for using the color registration apparatus.

2. Description of the Related Art

An electro-photographic printer such as a color laser printer includes four photoconductive drums, an exposing unit, a developing unit and a transferring belt. The four photoconductive drums respectively correspond to four colors such as yellow (Y), magenta (M), cyan (C) and black (K). The exposing unit radiates light onto each of the photoconductive drums, thereby forming an electrostatic latent image of an image to be printed.

The developing unit respectively develops the electrostatic latent image formed by the exposing unit for each color using a separate developing solution for each color. The transferring belt sequentially receives the images respectively developed on each of the photoconductive drums, superimposes these images to form a final color image, and then transfers the final color image onto paper.

Initial and final positions of the developed electrostatic latent images for the four colors are identically superimposed on the transferring belt to obtain a final color image identical to the desired color image. The exposure start timing for the photoconductive drums in the exposing unit should be accurately controlled in consideration of the transferring speed of the transferring belt to facilitate the accurate realization of a color image. The control of the exposure start timing is referred to as color registration.

An electro-photographic printer comprising a conventional color registration apparatus exposes, develops, senses a registration mark for each color and then performs color registration according to the time when each color is sensed before printing data.

The color registration apparatus radiates light of a predetermined emitting intensity onto the developed registration mark and senses a light of a predetermined intensity reflected from the developed registration mark, thereby sensing the developed registration mark.

The time when each color is sensed represents a time when the intensity of sensed light is greater than a predetermined threshold value. As the concentration of the developing agent decreases, the intensity of sensed light decreases.

Therefore, the conventional color registration apparatus cannot sense a developed registration mark when the concentration of a developing agent is too low which leads to erroneous performance of the color registration.

Accordingly, there is a need for an improved system and method for performing color registration without errors regardless of a concentration of a developing agent.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a color registration apparatus to perform color registration without errors regardless of a concentration of a developing agent by determining the intensity of light irradiated onto a registration mark and the minimum intensity of sensed light necessary for identifying the registration mark according to the concentration of the developing agent.

An exemplary embodiment of the present invention provides a color registration method to perform color registration without errors regardless of a concentration of a developing agent by determining the intensity of light irradiated onto a registration mark and the minimum intensity of sensed light necessary for identifying the registration mark according to the concentration of the developing agent.

An exemplary embodiment of the present invention also provides a computer-readable recording medium on which a program for executing a color registration method is recorded. The program performs color registration without errors regardless of a concentration of a developing agent by determining the intensity of light irradiated onto a registration mark and the minimum intensity of sensed light necessary to identify the registration mark according to the concentration of the developing agent.

According to an aspect of an exemplary embodiment of the present invention, a color registration apparatus is provided. A mark forming unit forms a concentration mark. for each color and forms a registration mark for each color in response to a color registration control signal. A mark sensing unit senses the concentration mark by emitting a plurality of first emitted lights comprising different intensities and senses the registration mark by emitting second emitted lights. An examining unit compares the intensities of first sensed lights with a predetermined reference value and generates the color registration control signal in response to the comparison results. A calculating unit calculates the intensity of the second emitted light using the intensities of the plurality of first emitted lights and the intensities of the plurality of first sensed lights if the intensities of second sensed lights are greater than a predetermined value. A color registration unit performs color registration using the intensity of the second sensed light which is greater than a predetermined threshold value, wherein the first sensed light is a light reflected from the concentration mark, and the second sensed light reflected from the registration mark.

The threshold value may be previously determined between the predetermined value and the minimum intensity of the second sensed light. The predetermined threshold value may be an average value of the predetermined value and the minimum intensity of the second sensed light. The predetermined value may be the maximum intensity of light which can be sensed by the mark sensing unit.

According to another aspect of an exemplary embodiment of the present invention, a color registration method is provided. A concentration mark is formed for each color and the concentration mark is sensed for each color by emitting a plurality of first emitted lights comprising different intensities. A determination is made as to whether the intensity of first sensed light reflected from the concentration mark corresponding to a chromatic color is greater than a predetermined reference value. A registration mark is formed for each color when the intensity of the first sensed light is greater than the predetermined reference value and the intensity of second emitted light reflected from the registration mark is calculated to be greater than a predetermined value for all colors using the intensities of the plurality of first emitted lights and the intensities of the plurality of first sensed lights. The registration mark is sensed by emitting the second emitted light comprising the calculated intensity and performing color registration using information on the time when the second sensed light comprising the greater intensity than a predetermined threshold value is sensed.

According to still another aspect of an exemplary embodiment the present invention, a computer-readable recording medium is provided. A program is recorded on the computer-readable recording medium to facilitate the execution of a method for spatial predictive encoding of video data. According to an exemplary implementation of the method, a concentration mark is formed for each color and the concentration mark is sensed for each color by emitting a plurality of first emitted lights comprising different intensities. A determination is made as to whether the intensity of first sensed light reflected from the concentration mark corresponding to a chromatic color is greater than a predetermined reference value. A registration mark is formed for each color when the intensity of the first sensed light is greater than the predetermined reference value and the intensity of second emitted light reflected from the registration mark is calculated to be greater than a predetermined value for all colors using the intensities of the plurality of first emitted lights and the intensities of the plurality of first sensed lights. The registration mark is sensed by emitting the second emitted light comprising the calculated intensity and performing color registration using information on the time when the second sensed light comprising a greater intensity than a predetermined threshold value is sensed.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram of a color registration apparatus according to an exemplary embodiment of the present invention;

FIG. 2 is a timing diagram illustrating the intensity of a first light and the intensity of a second light sensed by a mark sensing unit of FIG. 1; and

FIG. 3 is a flowchart of a color registration method according to an exemplary embodiment of the present invention.

Throughout the drawings, the same drawing reference numerals will be understood to refer to the same elements, features and structures.

### DETAILED DESCRIPTION OF EXEMPLARY EMBODIMETNS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

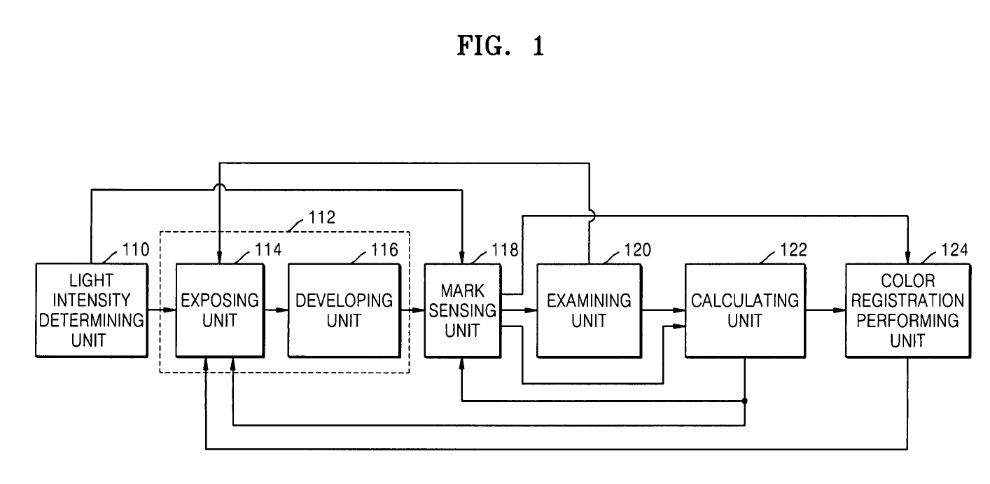

FIG. 1 is a block diagram of a color registration apparatus according to an exemplary embodiment of the present invention. Referring to FIG. 1, the color registration apparatus includes a light intensity determining unit 110 for determining the intensity of emitted light, a mark forming unit 112, a mark sensing unit 118, an examining unit 120, a calculating unit 122, and a color registration performing unit 124. The mark forming unit 112 includes an exposing unit 114 and a developing unit 116.

An electro-photographic image forming apparatus such as a color laser printer may include the light intensity determining unit 110, the mark forming unit 112 comprising the exposing unit 114 and the developing unit 116.

The light intensity determining unit 110 determines the intensity of a first emitted light for sensing a concentration mark in the mark sensing unit 118, which will be described later. The intensity of the first emitted light is transmitted to the mark sensing unit 118.

The light intensity determining unit 110 may previously separately determine a plurality of intensities of first emitted lights. According to an exemplary implementation, if the light intensity determining unit 110 separately determines two sets of intensities of the first emitted lights, the determined intensities are denoted as PWM1 and PWM2.

When the first lights PWM1 and PWM2 radiated onto a transferring belt are reflected before applying developing agents, the intensities of reflected lights sensed by the mark sensing unit 118 are denoted as BaseADC1 and BaseADC2. The light intensity determining unit 110 determines the intensities PWM1 and PWM2 for detecting BaseADC1 and BaseADC2 when the developing agent is applied onto the transferring belt. In this operation, a mark sensor installed in the mark sensing unit 118 is controlled.

The mark forming unit 112 forms a concentration mark for each color and then forms a registration mark for each color in response to a color registration control signal. The concentration mark is used to determine a concentration of a developing agent and the registration mark is used to perform color registration.

The colors are assumed to be yellow (Y), magenta (M), cyan (C), and black (K). Y, M, and C are chromatic colors, and K is an achromatic color K. The electro-photographic image forming apparatus includes a photoconductive drum for each color.

The mark forming unit 112 includes the exposing unit 114 and the developing unit 116. The exposing unit 114 scans light onto the photoconductive drums to form electrostatic latent images according to the concentration marks or the registration marks.

The developing unit 116 develops the electrostatic latent image for each color formed by the exposing unit 114 using a separate developing agent for each color. The transferring belt sequentially receives the electrostatic latent images respectively developed on each of the photoconductive drums.

The mark sensing unit 118 senses the concentration marks or registration marks formed by the mark forming unit 112. Specifically, the mark sensing unit 118 radiates a first light comprising a predetermined intensity onto each of the concentration marks, and senses lights reflected from the concentration marks, thereby sensing the concentration marks.

Similarly, the mark sensing unit 118 radiates a second light comprising a predetermined intensity onto each of the registration marks, and senses lights reflected from the registration mark, thereby sensing the registration marks.

When the mark sensing unit 118 senses the concentration marks, a plurality of first lights comprising different predetermined intensities may be radiated onto each of the concentration marks. The mark sensing unit 118 may radiate lights comprising one of the plurality of intensities separately determined by the light intensity determining unit 110 to facilitate the sensing of the concentration marks.

For this purpose, the mark sensing unit 118 receives the intensities of the first emitted lights from the light intensity determining unit 110.

For example, after the mark sensing unit 118 emits the first light comprising the intensity PWM1 to sense a concentration mark, the mark forming unit 112 forms a new concentration mark and then the mark sensing unit 118 emits the second light comprising the intensity PWM2 to sense the new concentration mark.

When the first lights PWM1 and PWM2 which have been radiated onto a transferring belt are reflected, the intensities of reflected lights sensed by the mark sensing unit 118 are denoted as ADC1 and ADC2.

The examining unit 120 compares the intensities ADC1 and ADC2 of the first sensed lights, which are reflected from the formed concentration marks, with a predetermined reference value, and generates a registration control signal in response to the comparison results. The generated registration control signal is input into the exposing unit 114.

If the mark sensing unit 118 emits a plurality of first lights comprising different intensities onto the concentration marks, the mark sensing unit 118 senses a plurality of lights reflected from the concentration marks. Then, the examining unit 120 separately compares the intensity of each of the sensed lights with the predetermined reference value.

For example, when the intensity of the first sensed light is from one of the concentration marks corresponding to Y, M, or C, the examining unit 120 estimates whether the intensity of the first sensed light is greater than the predetermined reference value. When the examining unit 120 estimates that the intensity of the first sensed light is greater than the predetermined reference value, the examining unit 120 generates a registration control signal.

Otherwise, when the intensity of the first sensed light is from the concentration mark corresponding to K, the examining unit 120 estimates whether the intensity of the first sensed light is less than the predetermined reference value. When the examining unit 120 estimates that intensity of the first sensed light is less than the predetermined reference value, the examining unit 120 generates a registration control signal.

The operations of the examining unit 120 may be performed for all colors. Thus, the examining unit 120 generates a registration control signal when the intensity of the first sensed light is greater than the predetermined reference value for Y, M, and C, or when the intensity of the first sensed light is less than the predetermined reference value for K.

The exposing unit 114 of the mark forming unit 112 operates in response to the generated registration control signal.

The calculating unit 122 calculates the intensities of second emitted lights by using the intensities of the first emitted lights and the intensities of the first sensed light. When second lights are radiated, the intensities of second sensed lights are greater than predetermined values for all colors.

The intensity of the second sensed light is denoted as PWM3, and the predetermined value is denoted as ADC3. ADC3 may be a maximum intensity of light sensed by the mark sensing unit 118. ADC3 is determined according to the hardware characteristics of the mark sensing unit 118.

The calculating unit 122 may operate when the examining unit 120 estimates that the intensities of the first sensed lights are greater than the predetermined reference value for Y, M, and C, or the intensities of the first sensed lights are less than the predetermined reference value for K.

For example, the calculating unit 122 may calculate the intensity PWM3 using intensities PWM1, PWM2, LowADC1, and LowADC2. LowADC1 denotes the lowest intensity of the first sensed lights when a light comprising the intensity PWM1 is emitted onto the concentration mark. LowADC2 denotes the lowest intensity of the first sensed light when a light comprising the intensity PWM2 is emitted onto the concentration mark.

The intensity of light sensed by the mark sensing unit 118 is proportional to the intensity of emitted light. That is, the intensity of the first sensed light is proportional to the intensity of the first emitted light, and the intensity of the second sensed light is proportional to the intensity of the second emitted light. Equations 1 and 2 may be derived from this relationship. The calculating unit 122 may calculate the intensity PWM3 using Equations 1 and 2.

$$\begin{matrix}( PWM 2 - PWM 1 ) \text{:} ( LowADC 2 - LowADC 1 ) = ( PWM 3 - PWM 1 ) \text{:} ( ADC 3 - LowADC 1 ) & ( 1 ) \\ PWM 3 = \frac{( PWM 2 - PWM 1 ) * ( ADC 3 - LowADC 1 )}{LowADC 2 - LowADC 1} + PWM 1 & ( 2 )\end{matrix}$$

The mark sensing unit 118 emits light comprising the intensity PWM3 and senses the registration mark. Accordingly, some of the intensities of the second sensed lights of Y, M, C, and K are greater than the predetermined value ADC3.

The color registration performing unit 124 senses the registration mark for each color formed by the mark forming unit 112, and performs color registration using information relating to the time when the registration mark for each color is sensed. Specially, the color registration performing unit 124 performs color registration using information relating to the time when the intensity of the second sensed light, which is greater than a sensed predetermined threshold value.

The threshold value may be previously determined using the predetermined value ADC3 and the minimum intensity of the second sensed light. The threshold value may be an average value of the predetermined value ADC3 and the minimum intensity of the second sensed light. The second sensed light comprising the minimum intensity may be reflected from the registration mark corresponding to K.

The registration marks of Y, M, and C are separately developed using a corresponding chromatic developing agent, but the registration mark corresponding to K is generally not developed using only an achromatic developing agent. If the registration mark corresponding to K is developed using only the achromatic developing agent, the reflection ratio is too low which reduces the mark sensing unit's 118 ability to sense the reflected lights. Accordingly, inversion portions of the registration mark corresponding to K are developed using the achromatic developing agent, and mark forming portions of the registration mark are developed using the chromatic developing agent.

When the registration mark corresponds to K, lights comprising low intensities are sensed at the portions developed using the achromatic developing agent, and lights comprising relatively high intensities are sensed at the portions developed using the chromatic developing agent. The high intensity of the sensed light is greater than the predetermined value ADC3.

The minimum intensity of the second sensed light may be obtained by Equation 3.

$$BlackADC 3 = \frac{( PWM 3 - PWM 1 ) * ( BlackADC 2 - BlackADC 1 )}{PWM 2 - PWM 1} + BlackADC 1 \qquad ( 3 )$$

where BlackADC3 denotes the minimum intensity of the second sensed light reflected from the registration mark corresponding to K.

Meanwhile, BlackADC1 denotes an average value of the intensities of the first sensed light when the emitted light comprising the intensity PWM1 is reflected from the concentration mark corresponding to K. BlackADC2 denotes an average value of the intensities of the first sensed light when the emitted light comprising the intensity PWM2 is reflected from the concentration mark corresponding to K.

According to an exemplary implementation, the threshold value may be an average value of BlackADC3 and ADC3.

The color registration performing unit 124 performs color registration using information relating to the time when the intensity of the sensed second light is greater than the threshold value.

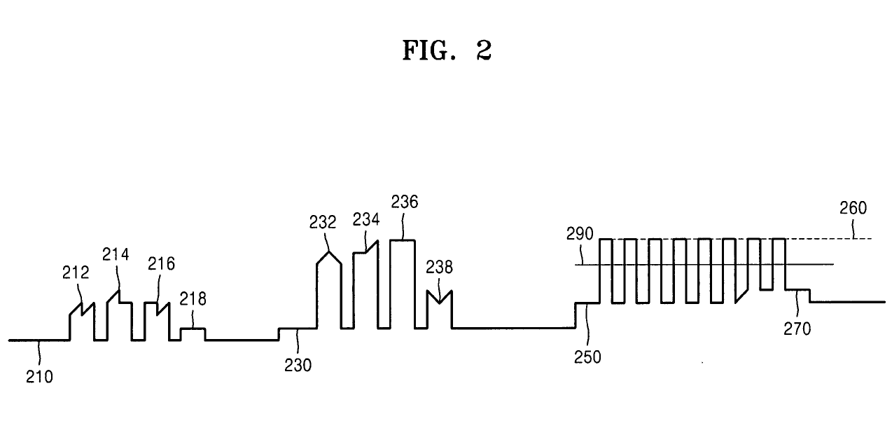

FIG. 2 is a timing diagram illustrating the intensity of a first sensed light and the intensity of a second sensed light sensed by a mark sensing unit 118 of FIG. 1. The reference numerals 210 and 230 denote BaseADC1 and BaseADC2, respectively.

Reference numerals 212, 214, 216, and 218 indicate the intensities of the first sensed lights when the emitted lights comprising the intensity PWM1 are reflected from the concentration marks corresponding to Y, M, C, and K, respectively

Reference numerals 232, 234, 236, and 238 indicate the intensities of the first sensed lights when the emitted lights comprising the intensity PWM2 are reflected from the concentration marks corresponding to Y, M, C, and K, respectively.

Reference numeral 250 denotes the intensity of the sensed light when the emitted lights comprising the intensity PWM3 onto the transferring belt are reflected. Reference numeral 260 denotes the predetermined value ADC3. Reference numeral 270 denotes the minimum intensity of the second sensed light BlackADC3 reflected from the registration mark corresponding to K. Reference numeral 290 denotes the threshold value.

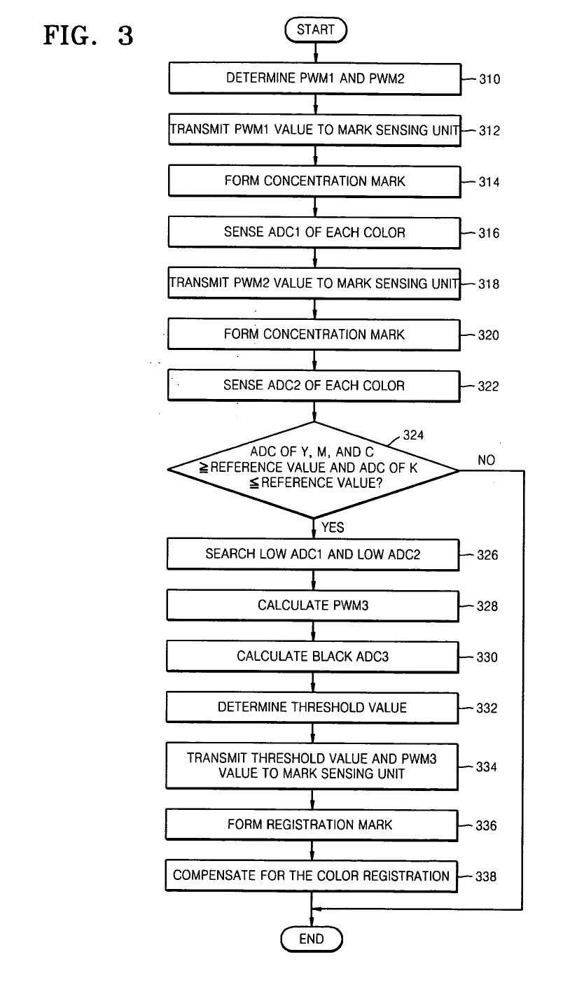

FIG. 3 is a flowchart of a color registration method according to an exemplary embodiment of the present invention. Color registration is performed in steps 310 through 338 without errors regardless of a concentration of a developing agent by determining the intensity of light irradiated onto a registration mark and the minimum intensity of sensed light necessary to identify the registration mark according to the concentration of the developing agent.

The light intensity determining unit 110 determines the intensities PWM1 and PWM2 in step 310. The determined value of the intensity PWM1 is transmitted to the mark sensing unit 118 in step 312. The mark forming unit 112 forms a first concentration mark in step 314. The mark sensing unit 118 emits light comprising the intensity PWM1 onto the first concentration mark and senses the first concentration mark in step 316.

The determined value of the intensity PWM2 is transmitted to the mark sensing unit 118 in step 318. The mark forming unit 112 forms a second concentration mark in step 320. The mark sensing unit 118 emits light comprising the intensity PWM2 onto the second concentration mark and senses the second concentration mark in step 322.

The examining unit 120 estimates whether the intensity of the second sensed light reflected from the concentration mark corresponding to Y, M, or C is greater than a predetermined reference value. The examining unit 120 estimates whether the intensity of the second sensed light reflected from the concentration mark corresponding to K is less than a predetermined reference value in step 324.

When the intensity of the second sensed light reflected from the concentration mark corresponding to Y, M, or C is greater than a predetermined reference value, and when the intensity of the second sensed light reflected from the concentration mark corresponding to K is less than a predetermined reference value, the calculating unit 122 searches for the lowest intensity LowADC1 of the first sensed light sensed in response to the intensity PWM1 and the lowest intensity LowADC2 of the first sensed light sensed in response to the intensity PWM2 in step 326.

Then, the calculating unit 122 calculates the intensity PWM3 using the intensities PWM1, PWM2, LowADC1, LowADC2, and ADC3 in step 328, calculates BlackADC3 using the intensity PWM3 in step 330, and determines a threshold value in step 332.

The value of the intensity PWM3 is transmitted to the mark sensing unit 118, and the determined threshold value is transmitted to the color registration performing unit 124 in step 334. The mark forming unit 112 forms a registration mark for each color in step 336.

The mark sensing unit 118 senses the registration mark by emitting a light comprising the intensity PWM3. Color registration is performed when the intensities of the second sensed light, which are greater than the threshold value, are sensed in step 338.

The exemplary embodiments of the present invention may be written as computer programs and may be executed in general-use digital computers that execute the programs using a computer readable recording medium. Examples of the computer readable recording medium include magnetic storage media (for example, ROM, floppy disks, and hard disks among others), optical recording media (for example, CD-ROMs, and DVDs among others), and storage media such as carrier waves (for example, transmission through the internet). The computer readable recording medium may also be distributed over network coupled computer systems so that the computer readable code is stored and executed in a distributed fashion. Functional programs, codes, and code segments for realizing the exemplary embodiments of the present invention may be easily modified by those of ordinary skill in the art.

As described above, the color registration apparatus and method according to the exemplary embodiments of present invention may perform color registration without errors regardless of a concentration of a developing agent by determining the intensity of light irradiated onto a registration mark. The minimum intensity of sensed light necessary to identify the registration mark is identified according to the concentration of the developing agent.

The color registration apparatus and method according to the exemplary embodiments of the present invention may determine the intensity of light irradiated onto a registration mark and the minimum intensity of sensed light necessary to identify the registration mark according to the concentration of a developing agent using the results of sensing concentration mark twice, thereby reducing the time for preparing the color registration and the amount of developing agents for the color registration.

While the present invention has been shown and described with reference to certain exemplary embodiments thereof, it will be understood by those of ordinary skill in the art that various changes in form and details may be made therein without departing from the spirit and scope of the present invention as defined by the appended claims and their equivalents.

What is claimed is:

1. A color registration apparatus comprising:
a mark forming unit for forming a concentration mark for each color and forming a registration mark for each color in response to a color registration control signal;
a mark sensing unit for sensing the concentration mark by emitting a plurality of first emitted lights comprising different intensities and sensing the registration mark by emitting second emitted lights;
an examining unit for comparing the intensities of first sensed lights with a predetermined reference value and generating the color registration control signal in response to the comparison results;
a calculating unit for calculating the intensity of the second emitted light using the intensities of the plurality of first emitted lights and the intensities of the plurality of first sensed lights if the intensities of second sensed light are greater than a predetermined value; and
a color registration unit for performing color registration using the intensity of the second sensed light than a predetermined threshold value, wherein the first sensed light comprises a light reflected from the concentration mark and the second sensed light reflected from the registration mark.

2. The color registration apparatus of claim 1, wherein the threshold value is previously determined between the predetermined value and the minimum intensity of the second sensed light.

3. The color registration apparatus of claim 2, wherein the predetermined threshold value comprises an average value of the predetermined value and the minimum intensity of the second sensed light.

4. The color registration apparatus of claim 1, wherein the plurality comprises two.

5. The color registration apparatus of claim 1, wherein the examining unit respectively compares the intensities of the plurality of first sensed lights with the predetermined reference value.

6. The color registration apparatus of claim 1, wherein the examining unit examines whether the intensity of the first sensed light reflected from the concentration mark corresponding to a chromatic color is greater than the predetermined reference value, and generates the color registration control signal in response to the examination result.

7. The color registration apparatus of claim 1, wherein the examining unit examines whether the intensity of the first sensed light reflected from the concentration mark corresponding to an achromatic color is less than the predetermined reference value, and generates the color registration control signal in response to the examination result.

8. The color registration apparatus of claim 1, wherein the predetermined value comprises the maximum intensity of light which can be sensed by the mark sensing unit.

9. The color registration apparatus of claim 1, wherein the intensities of the plurality of first emitted lights are previously differentially determined, and the mark sensing unit emits light comprising one of the determined intensities of the first emitted light to sense the concentration mark.

10. The color registration apparatus of claim 1, wherein the calculating unit calculates the intensity of the second emitted light using the following equation,
$$PWM 3 = \frac{( PWM 2 - PWM 1 ) * ( ADC 3 - LowADC 1 )}{LowADC 2 - LowADC 1} + PWM 1$$
where PWM1 and PWM2 comprises differentially determined intensities of the first emitted lights, PWM3 comprises the intensity of the second emitted light, LowADC1 and LowADC2 are the minimum intensities of the first sensed lights, and ADC3 comprise the predetermined value.

11. The color registration apparatus of claim 1, wherein the threshold value comprises an average of the intensity of the second sensed light reflected from the registration mark corresponding to an achromatic color and the predetermined value, wherein the intensities of the second sensed light are obtained by the following equation,
$$BlackADC 3 = \frac{( PWM 3 - PWM 1 ) * ( BlackADC 2 - BlackADC 1 )}{PWM 2 - PWM 1} + BlackADC 1$$
where BlackADC3 comprises the minimum intensity of the second sensed light reflected from the registration mark corresponding to the achromatic color, BlackADC1 and BlackADC2 are averages of the intensities of the first sensed lights reflected from the concentration mark corresponding to the achromatic color, PWM1 and PWM2 are the differentially determined intensities of the first emitted lights, and PWM3 comprises the intensity of the second emitted light.

12. A color registration method comprising:
forming a concentration mark for each color and sensing the concentration mark for each color by emitting a plurality of first emitted lights comprising different intensities;
determining whether the intensity of first sensed light reflected from the concentration mark corresponding to a chromatic color is greater than a predetermined reference value;
forming a registration mark for each color when the intensity of the first sensed light is greater than the predetermined reference value;
calculating the intensity of second emitted light reflected from the registration mark greater than a predetermined value for all colors using the intensities of the plurality of first emitted lights and the intensities of the plurality of first sensed lights; and
sensing the registration mark by emitting the second emitted light comprising the calculated intensity and performing color registration using information relating to a time when the second sensed light comprising an intensity greater than a predetermined threshold value is sensed.

13. The color registration method of claim 12, wherein the threshold value is previously determined between the predetermined value and the minimum intensity of the second sensed light.

14. The color registration method of claim 13, wherein the predetermined threshold value comprises an average value of the predetermined value and the minimum intensity of the second sensed light.

15. The color registration method of claim 12, wherein the plurality comprises two.

16. The color registration method of claim 12, wherein the forming and sensing a concentration mark for each color comprises:
forming a first concentration mark for each color and sensing the first concentration mark for each color by emitting the first emitted light comprising a first intensity; and
forming a second concentration mark for each color and sensing the second concentration mark for each color by emitting the sensed emitted light comprising a second intensity.

17. The color registration method of claim 12, wherein the determination determines whether the intensity of the first sensed light reflected from the concentration mark corresponding to the achromatic color is less than the predetermined reference value, and the formation forms the registration mark for each color when the intensity of the first sensed light is less than the predetermined reference value.

18. A computer-readable recording medium comprising recorded thereon a program for executing a method for spatial predictive encoding of video data, the method comprising:
forming a concentration mark for each color and sensing the concentration mark for each color by emitting a plurality of first emitted lights comprising different intensities;
determining whether the intensity of first sensed light reflected from the concentration mark corresponding to a chromatic color is greater than a predetermined reference value;
forming a registration mark for each color when the intensity of the first sensed light is greater than the predetermined reference value;
calculating the intensity of second emitted light reflected from the registration mark greater than a predetermined value for all colors using the intensities of the plurality of first emitted lights and the intensities of the plurality of first sensed lights; and
sensing the registration mark by emitting the second emitted light comprising the calculated intensity and performing color registration using information relating to a time when the second sensed light comprising an intensity greater than a predetermined threshold value is sensed.

19. The method of claim 18, wherein the threshold value is previously determined between the predetermined value and the minimum intensity of the second sensed light.

20. The method of claim 19, wherein the predetermined threshold value comprises an average value of the predetermined value and the minimum intensity of the second sensed light.

21. The method of claim 18, wherein the forming and sensing a concentration mark for each color comprises:
forming a first concentration mark for each color and sensing the first concentration mark for each color by emitting the first emitted light comprising a first intensity; and
forming a second concentration mark for each color and sensing the second concentration mark for each color by emitting the sensed emitted light comprising a second intensity.

22. The method of claim 18, wherein the determination determines whether the intensity of the first sensed light reflected from the concentration mark corresponding to the achromatic color is less than the predetermined reference value, and the formation forms the registration mark for each color when the intensity of the first sensed light is less than the predetermined reference value
